(19) United States
(12) Patent Application Publication
(10) Pub. No.: US 2012/0014223 A1
(43) Pub. Date: Jan. 19, 2012

(54) DEVICE INCORPORATING BOTH LIVE AND STATIC ADJUSTMENT FEATURES FOR DETERMINING FEEDING TIMES AND POSITION

(75) Inventor: Aindrea McKelvey Campbell, Beverly Hills, MI (US)

(73) Assignee: THE ATHENA COMPANY, LLC, Beverly Hills, MI (US)

(21) Appl. No.: 13/241,314

(22) Filed: Sep. 23, 2011

Related U.S. Application Data
(63) Continuation-in-part of application No. 12/540,608, filed on Aug. 13, 2009, now Pat. No. 8,050,147.
(60) Provisional application No. 61/099,026, filed on Sep. 22, 2008.

(51) Int. Cl. G04B 47/00

(52) U.S. Cl. 368/10

(57) ABSTRACT

A breastfeeding assist timepiece which includes a live time display combined with an iteratively resettable display, such further including a rotatable bezel feature which is repositionable between right and left sides of an associated crystal display and which, in combination with optional hour markings placed along the crystal display sides or upon the rotatable bezel, assists in establishing a dual-breast feeding cadence.

### CROSS-REFERENCE TO RELATED APPLICATIONS

This application is a Continuation-in-part of application Ser. No. 12/540,608 filed on Aug. 13, 2009, which in turn claims the benefit of U.S. Provisional Application 61/099,026 filed on Sep. 22, 2008.

### FIELD OF THE INVENTION

The present invention relates generally to a timepiece device for use by breast feeding mothers. More particularly, the present invention discloses a wearable breastfeeding watch, and which includes a live time display combined with an iteratively resettable display, such further including a rotatable bezel feature which is repositionable between right and left sides of an associated crystal display and which, in combination with optional hour markings placed along the crystal display sides or upon the rotatable bezel, assists in establishing a dual-breast feeding cadence.

### BACKGROUND OF THE INVENTION

Timer devices are well known in the relevant art. A particular subset species of timers specifically deals with baby care timers, such as reminding iterative feeding and napping times.

The itzbeen baby timer teaches a portable device with up to four digital timers, such as which can correspond to changing, feeding, sleeping, and medication schedules. Of note, the itzbeen device includes a nursing reminder with a left/right side indicator.

A related disclosure teaching a breast feeding timer is described in Juve U.S. Pat. No. 4,972,391 and incorporates an electronic circuit for counting an elapsed time in minutes succeeding a previously initiated nursing session. The elapsed time is presented upon a visual display which also includes a left/right side breast sub-display for indicating the breast from which the baby was last fed. The timer also includes a reference clock, clock counter, alarm counter and three digit digital display including separate right/left sub-displays, and an audible alarm.

German reference DE 101 29 621 teaches a breast feeding watch with an analog face and within which is set twin digital dynamic displays, each being a chronograph dynamically displaying the duration of time since the last feeding from either a left or right side breast.

Reiner U.S. Pat. No. 5,691,932 teaches a care giver data collection and reminder system for providing a range of baby care information entry fields, among them including feeding times and left/right side breast indicator.

Additional references of note include Nomura U.S. Pat. No. 4,338,680, which teaches an earlier version of analog display watch with digital inset for displaying alarm time information as well as the dual timing event stopwatch of Rose U.S. Pat. No. 4,505,595.

### SUMMARY OF THE INVENTION

The present invention discloses a wearable breastfeeding wristwatch which is an improvement over prior art breastfeeding watches and timer devices in that it provides a more convenient display and user functionality for comparing a current elapsing time with a static and resettable display time, combined with a left/right indication for determining the breast employed in a previous feeding session. As will be further described, the invention includes a series of alternate configurations which combine a live (typically analog) time display with a rotatable bezel which is movable between right and left side to indicate last breast expressed, along with additional hour markers (1-12) defined along either or both sides of the watch to confirm a most previous feeding time.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental perspective view of the breast feeding watch according to one preferred embodiment of the present invention;

FIG. 2 is an illustration of a timepiece device according to the present invention, and by which an upper display indicates a current time;

FIG. 3 is a similar illustration and further indicating the features of a bottom static and manually re-adjustable display, this being continuously reset to a time of last feeding;

FIG. 4 is a further succeeding illustration and showing the feature of the Left/Right indicator;

FIG. 5 is an illustration showing the manner in which the present device operates in a first predictive fashion to estimate a future expected feeding time (based upon the last feeding time indicated on the statically reset dial), as well as a second cadence indicating fashion in which, by indicating which side (left or right breast) was previously employed at the commencement of the last feeding, what side is preferred at the initiation of the next feeding (the alternate);

FIG. 6 is an illustration of a further variant in which static and dynamic analog displays are superimposed on a dial face, combined with a separate left/right side indicator;

FIG. 7 illustrates another variant combining the superimposed analog displays of FIG. 6 with a rotating left/right indicating bezel;

FIG. 8 is illustrates another variant in which the rotating bezel of FIG. 7 is combined with a static inset analog display in the form of a small dial;

FIG. 9 illustrates another variant in which the static analog display of FIG. 8 is substituted by a digital inset display combined with a left/right breast indicator and which is (re)set by a pair of push buttons located along the bottom of the bezel display;

FIG. 10 illustrates a still further variant in which both dynamic and static displays are provided in digital fashion upon a dial face;

FIG. 11 is a plan view of a breast feeding watch according to a yet further preferred embodiment and depicting a single analog live display combined with a jewel (directional indicator) supported within a rotatable outer bezel, the same being repositionable between right and left sides in order to indicate a last breast expressed, combined with a secondary and coaxially interiorly positioned rotatable ring which includes an additional arrow indicated for setting to a last preceding feeding time;

FIG. 12 is a cutaway view taken along line 12-12 of FIG. 11 and illustrating the beveled relationship associated with the inner coaxial ring and an externally located rotating wheel for actuating the internal gear relationship within the watch case;

FIG. 13 is a plan view of an alternate watch variant in which fixed hour markings 1-12 are imprinted along opposite sides of the fixed dial face and, in combination with a reconfigured rotatable outer bezel with arrow indicator, is iteratively adjustable to a given side and time setting to indicate both last breast expressed and the time of the most recent feeding;

FIG. 14 is a plan view of a related variant in which a single set of 1-12 hour markings are imprinted upon a rotatable outer bezel and, in combination with identical left/right side markings located upon the dial face, can be aligned at a given location to simultaneously indicate a last breast expressed and most recent time of feeding;

FIG. 15 is a plan view of another variant in which an inner rotatable positioned coaxial ring (such as depicted in FIGS. 11-12) exhibits 1-12 hour markings and is resettable, via the rotating knob or wheel, to either of identical left/right side markings located on the surrounding casing edges; and

FIG. 16 is a plan view of a yet further variant in which the inner rotatable ring, similar to as originally described in FIGS. 11-12, presents a single indicator marking (e.g. triangle), and which is repositionable relative to either of first and second identical and fixed hour markings 1-12 presented on both right and left sides of the dial face.

### DETAILED DESCRIPTION OF THE PREFERRED EMBODIMENTS

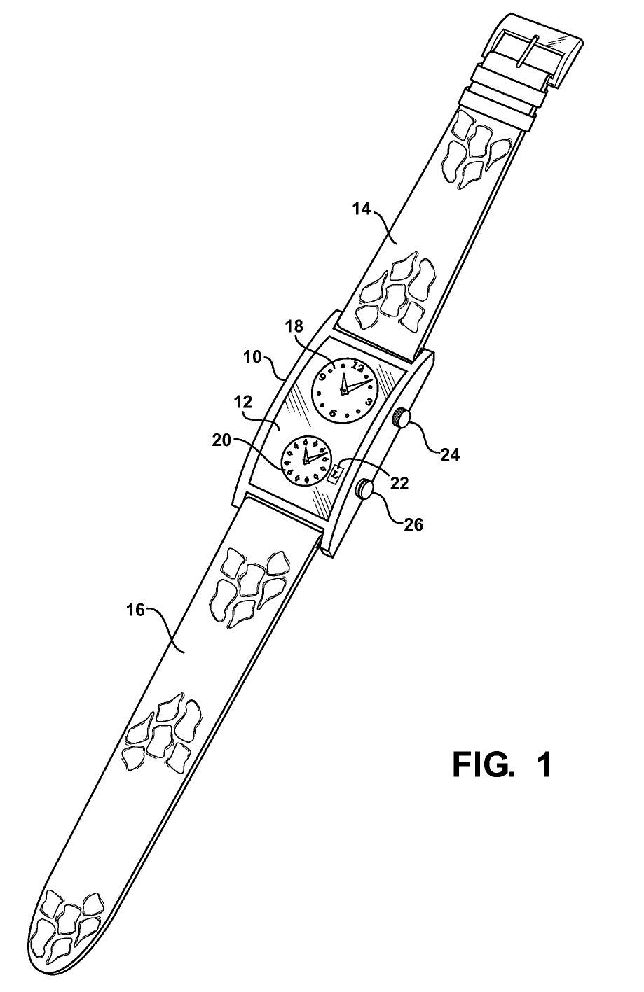

Referring to FIG. 1, the present invention discloses a wearable breastfeeding watch including a timepiece casing 10 exhibiting a display face 12 and further showing first 14 and second 16 end engageable straps portions extending from opposite ends of the casing. As further shown, the display face 12 includes a first (live or dynamic) analog time display 18 and a second likewise analog (dummy or static) and iteratively resettable display 20. Although not described in detail, it is understood that the breastfeeding watches, according to any of the embodiments disclosed herein, incorporates suitable gear geometry and/or digital processing components for providing optimal functionality.

A Left/Right indicator 22 is also provided and which, when set to a side in which a most recent feeding occurred, assists in establishing a dual-breast feeding cadence, and which allows the user to resume a future feeding such as with the other breast. Also shown at 24 is a first pull out and reset dial associated with the live display 18, and further at 26 is a second two position reset dial for controlling, in a first pull-out position, the left or right side indicator 22 and, in a second further pull-out position, the reset static time 20. Other envisioned variants include the two-position reset dial controlling in one pull-out position, either of the reset static time 20 or right/left side indicator 22. The terms dial, crown and knob are also understood to be used interchangeably when referencing the elements 24 and 26.

The incorporation of the device as a wearable timepiece is a preferred application, and given the high degree of mobility which normally attends daily life. That said, it is also envisioned that the timepiece device can also be provided as a table-top display, such as positioned proximate a feeding chair and in instances where a prolonged period of successive feedings are intended to occur at a static location.

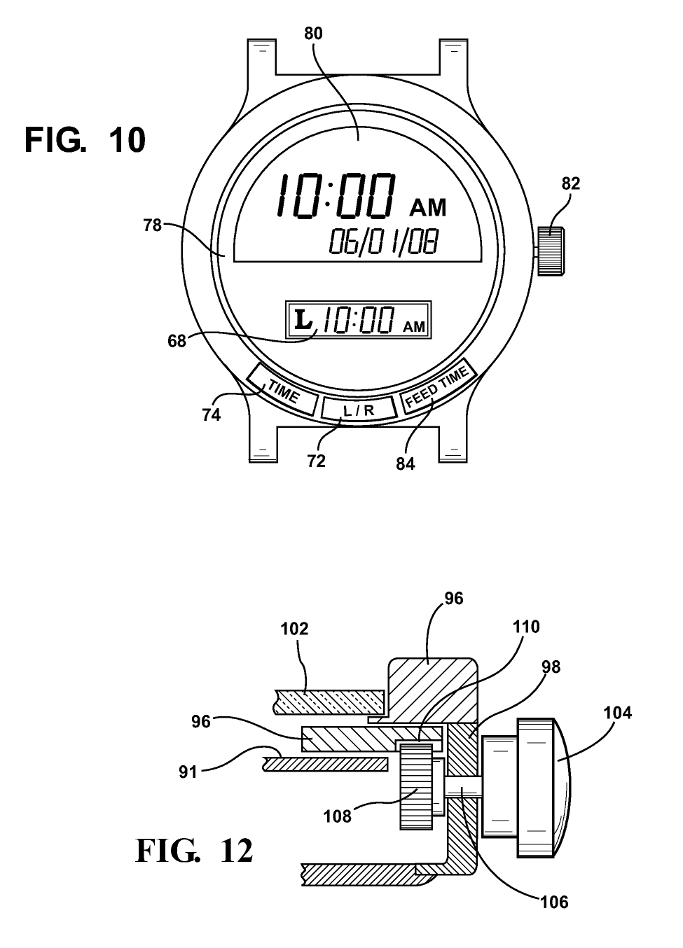

The timepiece, according to other desired embodiments, can also constitute such as a wearable pendant, and such as which can be utilized in combination with a chain or the like (not shown). As is also known, a battery (e.g. lithium ion) or other portable power source is provided for operating the live/dynamic display, as well as any digital aspects associated with the static display or left/right indicator and as will be subsequently described in more detail with reference to the alternate variants of FIGS. 9 and 10.

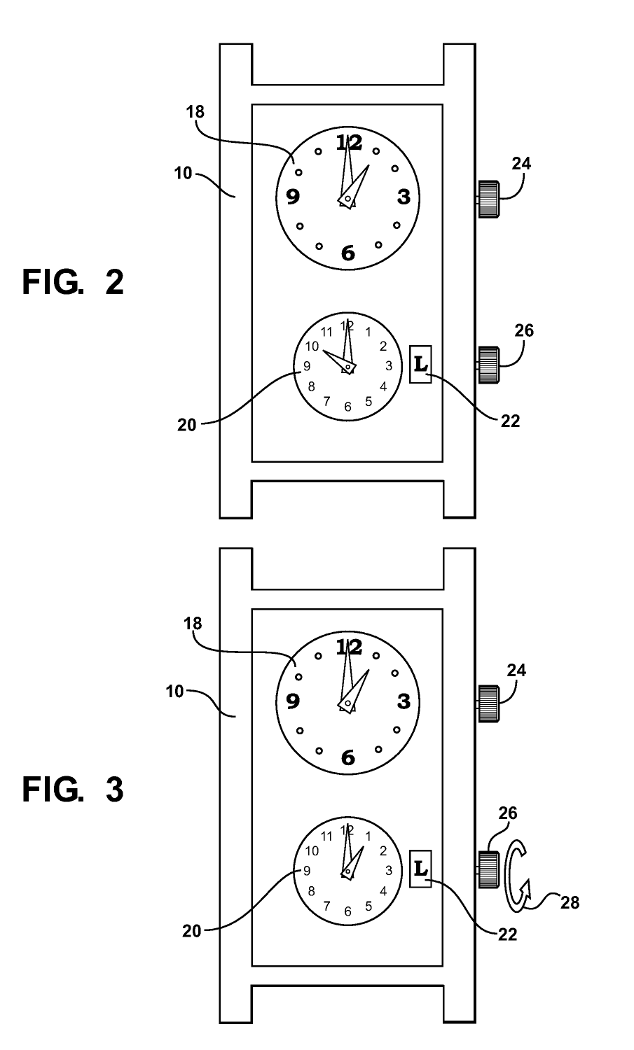

FIGS. 2-5 illustrate in further detail the protocol surrounding the operation of the breastfeeding wristwatch 10 shown in FIG. 1. Referring first to FIG. 2, an illustration is shown similar to that in FIG. 1 and further indicating the features of the bottom static and manually re-adjustable display 20 being iteratively and manually reset, via associated two position reset dial 26, to a time of last feeding. As such the bottom display 20 does not advance unless prompted by the user.

Each time the user breastfeeds, the user resets the bottom display 20 to the time of the feeding via dial 26. By the example shown in FIG. 3, breast feeding started at 1:00 pm (which is indicated on the upper dial 18) and, hence, the lower time display 20 is reset to this time (see also arrow 28).

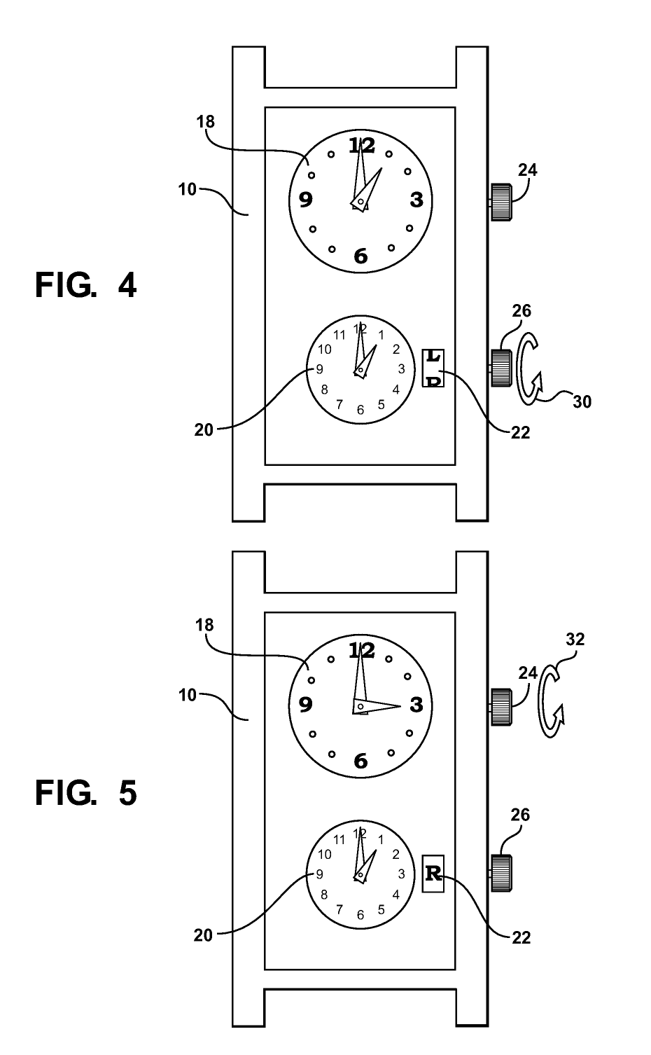

As further shown in FIG. 4, the feature of a Left/Right (breast) side indicator is again shown, at 22, and which is iterated between “L” and “R” side designations, such as by repositioning the reset dial 26 to a second position. The indicator 22 is successively reset by the dial 26 (see arrow 30 which differs from arrow 28 in FIG. 3 in that it represents the second adjustment position associated with dial 26), each time the user breast feeds, to the last breast at which feeding initiated (i.e. either the left or right).

It is also noted that the baby may feed from both breasts at a given feeding. The present invention allows breast feeding person to keep track of which side feeding started on in order to ensure 1) fully emptying at least one breast and 2) alternating sides to ensure balanced milk production.

FIG. 5 is a further illustration showing the manner in which the present device operates in a first predictive fashion to estimate a future expected feeding time (based upon the last feeding time indicated on the statically reset dial). A second cadence promoting fashion also instructs, by indicating which breast was previously employed at the commencement of the last feeding, what side is preferred at the initiation of the next feeding (the alternate). Upper arrow 32 also represents the optional readjustment aspect of the dial 24 relative to the live/dynamic display and on an as-needed basis.

In the example illustrated, and as time progresses, the user can reference the lower (statically reset) display 20 to recall how much time has elapsed since the last breast feeding occurred. As illustrated, the last feeding was at 1:00 (again display 20), and which was 2 hours earlier than the current indicated time (3:00) indicated by the upper (live) display 18. This feature helps to predict the time for the next feeding, as well as providing for better interpretive analysis of the baby's crying. Additionally, the breast feeding person can reference the L/R indicator to know which side the baby was last initially fed on, and hence, which side is preferred for the upcoming feeding (the other breast).

The left/right indicator is manually adjusted in this fashion, and thereby establishes a pattern, or cadence, this allowing the mother to keep track of which is the appropriate breast to use initially during feeding. Further, the left/right indicator supports two distinct methodologies of breastfeeding (among potentially others); single breast per feeding or both (dual) breasts per feeding. The former consists of the mother offering only one breast to the infant for a given feeding and then alternating which side is offered at the next feeding (e.g., ˜3 hours later). Symbolically, this may be shown as:
L, R, L, R, L, R, etc.

Where each letter representing left or right constitutes a single feeding separated by commas in the above series. The latter method (both breasts per feeding) is believed to be more healthful for the infant as it ensures that the baby ingests hind-milk (see below) as it guarantees that the infant will completely empty the first breast (e.g. left) before continuing feeding on the second breast (e.g. right). Again, in this methodology, the mother alternates sides from which to initiate feeding and this may be symbolically described as:
L-R, R-L, L-R, R-L, etc.

Most importantly, the left/right indicator of the invention supports both, or other, methodologies, and hence, is an advancement over prior art. In particular, the dual breast cadence has not previously been supported effectively elsewhere.

It has been well documented that managing breast feeding cadence imparts significant health benefits for the infant. In particular, it is known from available medical research the importance of ensuring that the infant ingests hind-milk (this being released at the end of the feeding from a given breast), and which is known to have a higher fat content as compared to foremilk (this released by a given breast at the start of the feeding). The further significance of hind-milk is that it contains a predominant amount of the calories and nutrients (as compared to foremilk), this further having been documented to reduce colic and critical in avoiding lactose mal-absorption, a painful condition which can cause malnutrition and diarrhea in the infant.

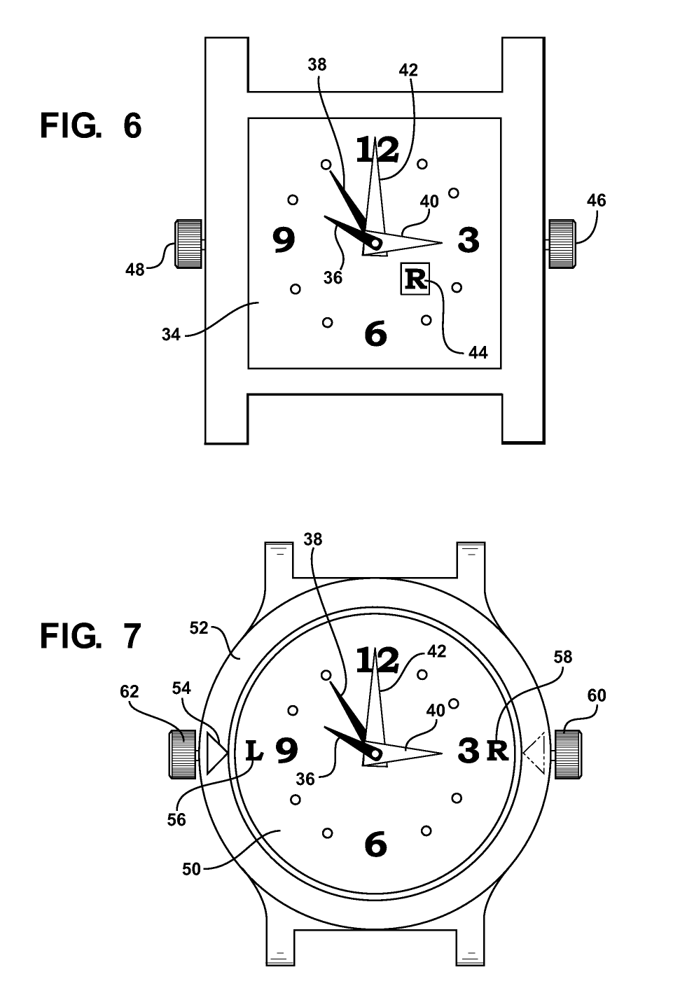

Referring to each of FIGS. 6-10, a series of alternate variants are depicted of the breastfeeding watch. Beginning with FIG. 6, illustrated is a further variant in which a redesigned display face 34 incorporates both static (hour hand 36 and minute hand 38) and dynamic (hour hand 40 and minute hand 42) analog displays which are superimposed on a common supporting axis associated with the dial face 34, and combined with a separate left/right side indicator 44.

To avoid confusion, the respective pairs of dynamic and static hands can be designed or dimensional differently (e.g. different shapes or sizes), or can be colored differently, such as by selecting easily differentiable colors (e.g. red and black respectively). It is also envisioned that either or both of the pairs of arms can include phosphorescent or fluorescent capabilities, in order to assist in being easily visible in the dark. Without limitation, appropriate backlighting capabilities can also be incorporated into any of the watch casings disclosed in the several embodiments herein.

A right side located dial 46 adjusts in either of first and second positions the static hour 36 and minute 38 hands, as well as the left/right indicator 44. A left side located dial 48 is also provided for resetting the dynamic hands 40 and 42.

FIG. 7 illustrates another variant in which a redesigned (rounded) face 50 combines the superimposed analog displays of FIG. 6 (see again static hands 36 and 38 with dynamic hands 40 and 42). The indicator 44 in FIG. 6 is removed and is substituted by a rotatable and outer ring shaped bezel 52, this further including an arrow, or other indicating feature, designation 54 which is rotated 180° between a first position (shown) in which it aligns with a left side indicia marking 56 and a second position (shown in phantom) in which it further aligns with a right side indicia marking 58.

The rotating bezel and left and right side indicia, can incorporate other types of indicator markings, not limited to the use of color coding or shapes, and can include such as jewels (crystals) placed on left and right sides of the dial face in substitution to that shown. Hence, such left and right side indicia may be explicitly represented with letters L and R or implicitly with jewels or other markers, located on the left and right side of the timepiece, accordingly. Additional features include one position adjustment dial 60 for resetting static arms 36 and 38, as well as corresponding dial 62 for resetting dynamic hands 40 and 42.

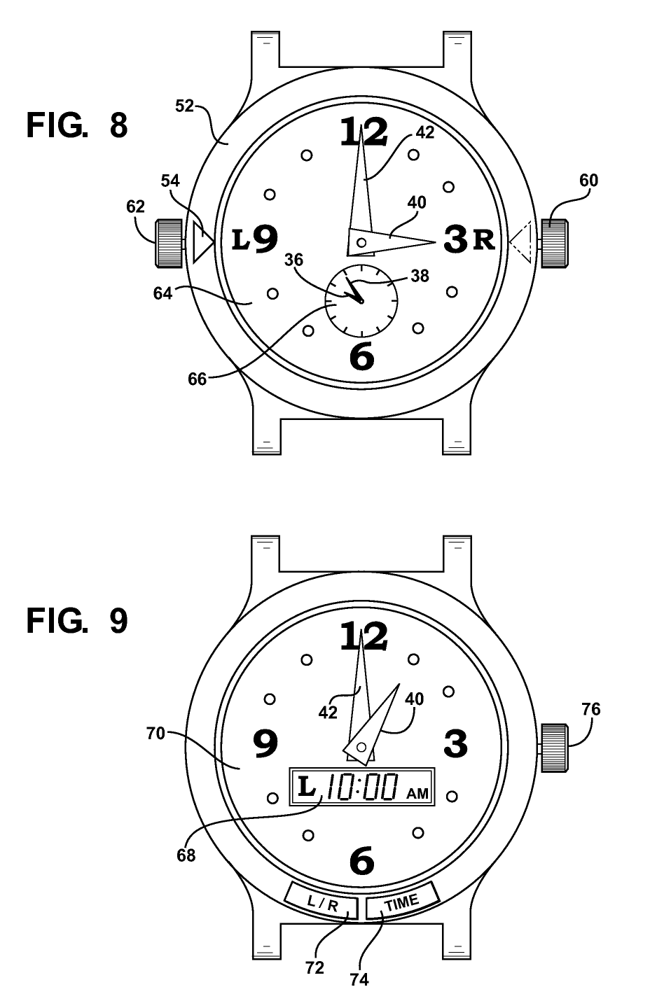

Referring now to FIG. 8, illustrated is another variant in which the rotating bezel 52 of FIG. 7 is combined with a redesigned casing and face 64 in which the analog hands 40 and 42 are combined with a redesigned and static smaller sized inset analog display 66. Adjustment dials 60 and 62 are repeated from FIG. 7 and function similarly in this variant. It is also envisioned that the rotating bezel can be substituted in favor of a left/right window display such as is previously shown at 44 in FIG. 6.

FIG. 9 illustrates another variant in which the static analog display of FIG. 8 is substituted by a digital inset display 68 combining a left/right breast indicator and incorporated into a further revised display 70. A pair of push buttons are provided and include L/R button 72 and time button 74, these being located along the bottom of a bezel display and which are individually depressible in order the L/R and time components of the combined display 68 are controlled and manipulated. Dial 76 is also provided along a side of the casing to set the actual hands 40 and 42.

FIG. 10 illustrates a still further variant in which a combined casing and face 78 incorporates both a dynamic digital display 80 in combination with the digital static display 68 previously shown in FIG. 9. Features include the actual time 80 also including a date indication and which is reset by dial 82. L/R and Time buttons 72 and 74 are again illustrated along a bottom of the display. Additionally provided is a feed time button 84 and which can optionally trigger the static display 68 to operate as a live/dynamic display. The feed time 84 can also function as a chronograph (i.e., to show the elapsed time when the button is depressed).

Referring now to FIG. 11, a plan view is generally depicted of a breast feeding watch according to a yet further preferred embodiment and which depicts a single analog live display (see hour 86, minute 88 and second 90 arms positioned upon an associated dial face 91 including circumferentially perimeter imprinted time markings) combined with a first directional indicator (jewel) 92, and which can additionally include any suitable symbol or design. The jewel 92 is supported within a rotatable outer bezel 94 (which depicts a first of two individually rotatable elements), the same being repositionable between right and left sides (typically 3 o'clock position for indicating right breast and 9 o'clock position for left breast) in order to indicate a last breast expressed. Additional embodiments contemplate the jewel being replaced by any of a stamped icon, molded shape or other form.

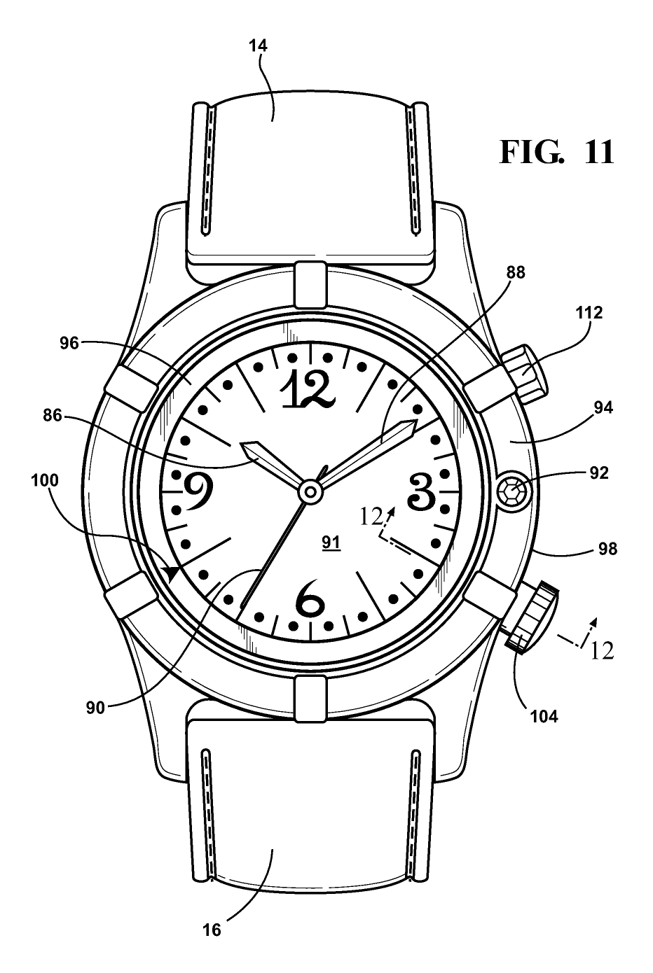

With additional reference to the cutaway of FIG. 12, a secondary and coaxially interiorly positioned rotatable ring 96 (defined as a second rotatable element distinct from the rotatable bezel 94) is provided within the watch case or enclosure 98 (depicted with straps 14 and 16 such as previously described). The inner ring 96 can exhibit either a level/flat or sloping upper surface and includes an additional type of directional indicator (shown as arrow 100 in FIG. 11) for setting to a last preceding feeding time. In the example of FIG. 11, the directional arrow 100 (which can also include a star, pearl or other shape) is repositioned to 8 o'clock and, combined with the jewel 92 rotated to the 3 o'clock position, indicates a right side breast last expressed at 8 o′ clock.

Referring again to FIG. 12, the cutaway view illustrates a surface crystal 102 covering the watch case enclosure 98 and, further better illustrates a beveled relationship associated with the inner coaxial ring 96 and an externally located rotating wheel 104 for actuating an internal gear relationship within the watch case. This further includes a shaft 106 extending from the wheel 104 internally through the side of the watch enclosure 98 to a terminating location at which a first gear 108 is secured. The gear 108 includes a circumferentially extending teethed pattern which interengages with additional teeth or serrations defined along an underside circumferential perimeter of the interiorly positioned and arrow indicating supporting ring 96, such as in order to rotatably adjust the arrow indicator 100 (depicted in FIG. 11 at 8 o'clock position) independently from a separate winding/adjustment wheel 112 (generally defined as an exterior adjustment feature) for setting the live time display (hands 86, 88 and 90).

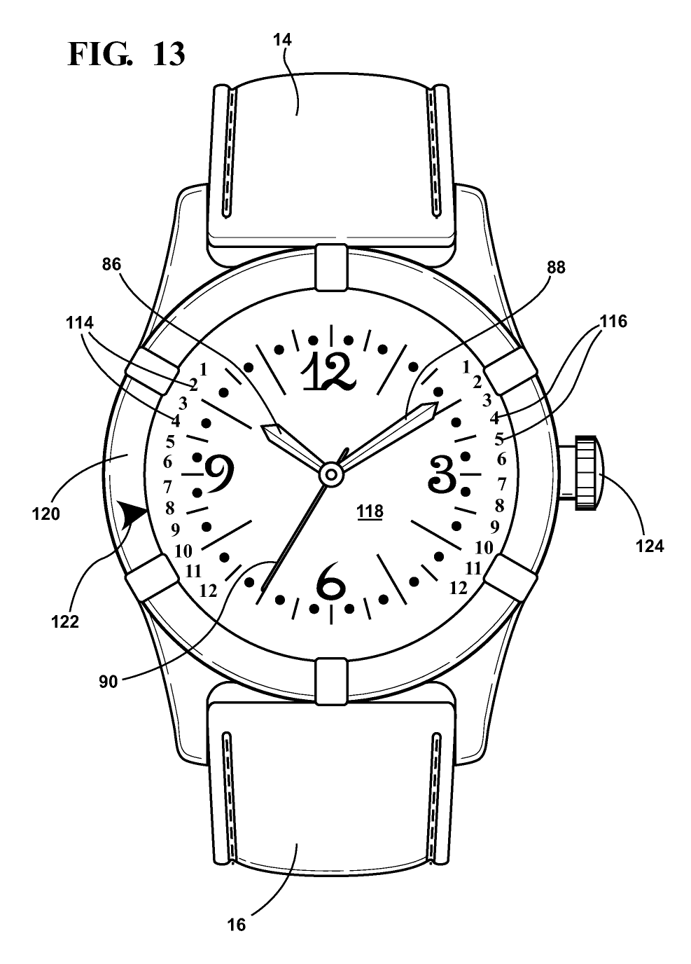

Proceeding to FIG. 13, a plan view is shown of an alternate watch variant in which fixed hour markings 1-12 (collectively referenced at 114 and 116) are imprinted along opposite sides of fixed dial face 118 and, in combination with a reconfigured rotatable outer bezel 120 with arrow indicator 122, is iteratively adjustable to a given side and time setting (such as again 8 o'clock on the left side) to indicate both last breast expressed (left) and the time (again 8 o'clock) of the most recent feeding. A live time winding/adjustment wheel 124 is again depicted extending from a side of the watch casing and the rotatable and exteriorly accessible bezel 120 is otherwise adjustable a full 360° range in order to set the arrow 122 or other suitable directional indicator to the correct location.

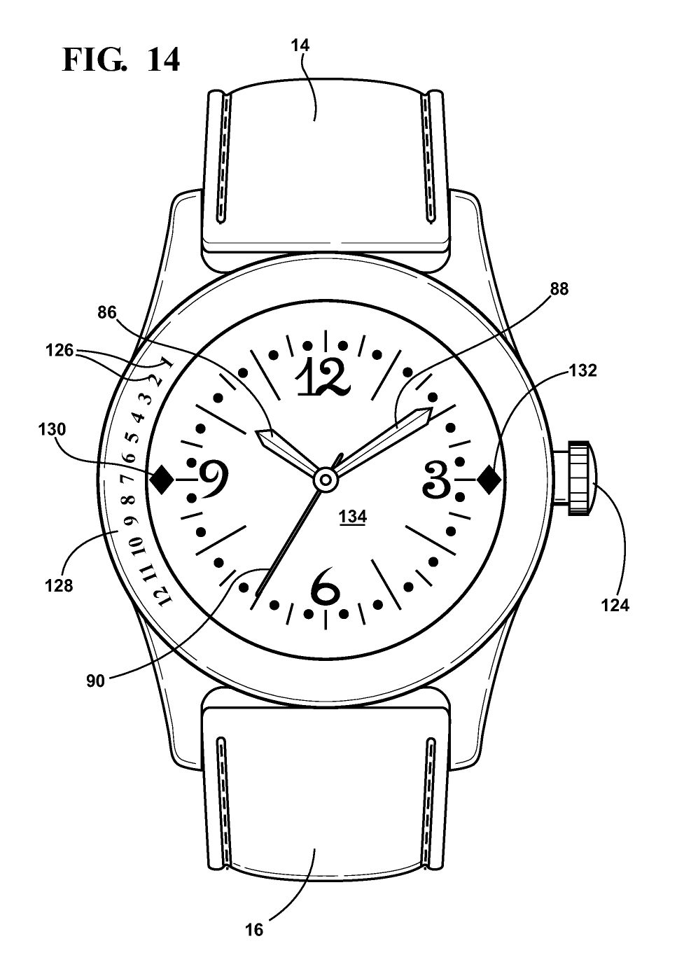

FIG. 14 is a plan view of a related variant in which a single set of 1-12 hour markings (collectively at 126) are imprinted upon a likewise rotatable outer bezel 128 and, in combination with identical left/right side markings 130 and 132 located upon dial face 134, can be aligned at a given location to alternately indicate a last breast (left) expressed and most recent time (shown as 7 o'clock) of feeding. Although not shown, the bezel 128 can include any pattern of integrally defined protuberances or raised portions to facilitate rotation. Live time winding/adjustment wheel 124 is again shown and otherwise the watch casing includes a similar collection of features as previously described.

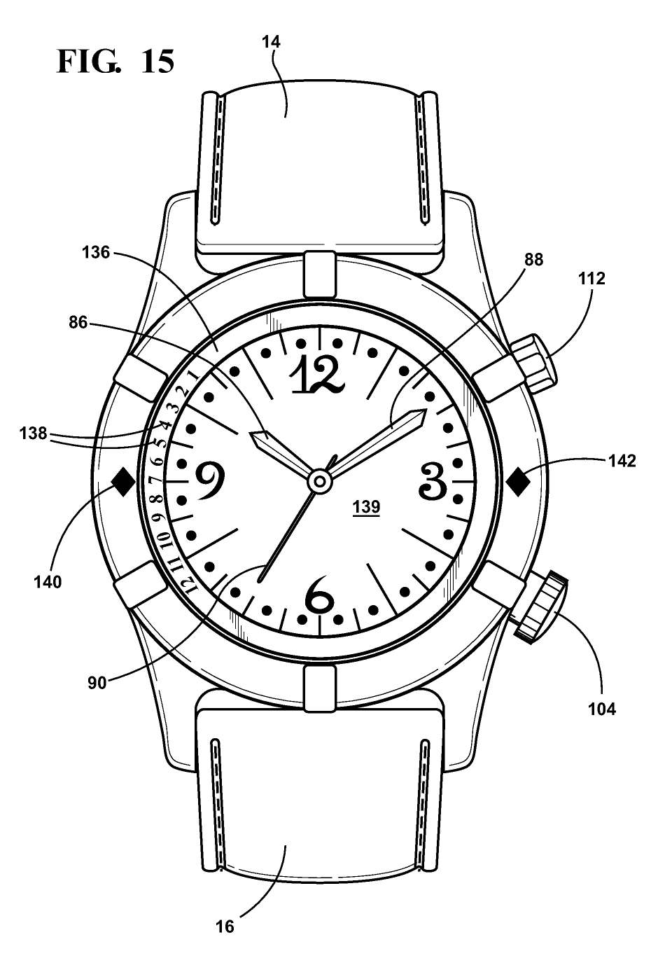

FIG. 15 is a plan view of another variant in which an inner rotatable positioned coaxial ring 136 (similar in construction as compared to inner ring 96 in FIGS. 11-12) exhibits 1-12 hour markings, collectively referenced at 138, imprinted on coaxial ring 136 surrounding display face 139. The inner ring 136 is resettable, via the rotating knob or wheel 104 as previously described in FIGS. 11-12, to either of identical left/right side markings, see further at 140 and 142, located on the surrounding casing edges and further such that the example of FIG. 15 depicts a left breast last expressed at 7 o'clock.

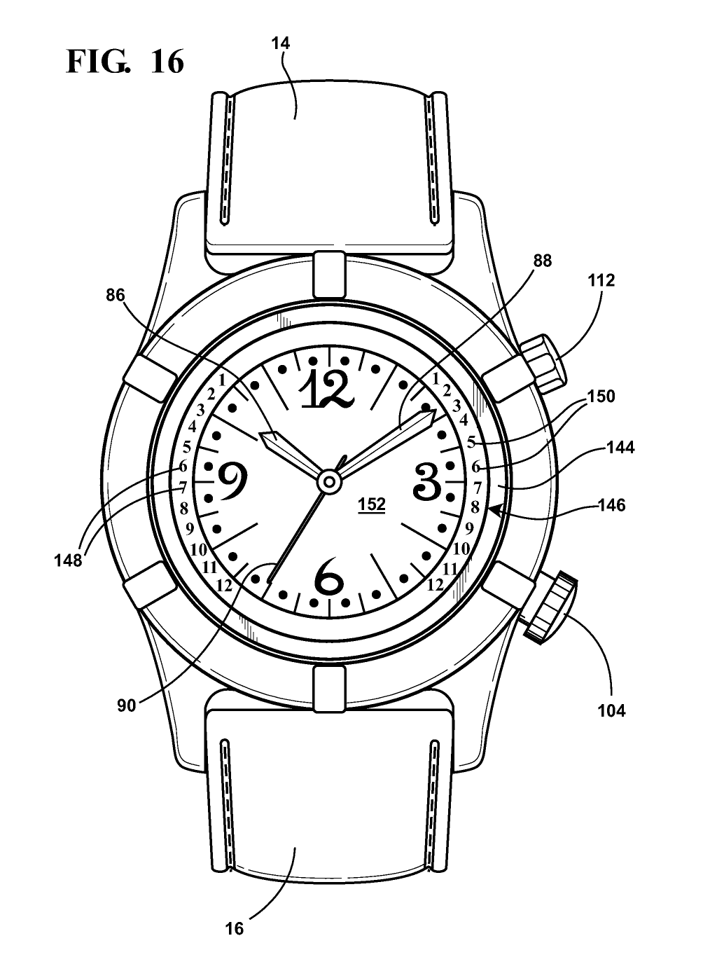

Referring finally to, FIG. 16 is a plan view of a yet further variant in which an inner rotatable ring 144, similar to as originally described at 96 in FIGS. 11 and 12, presents a single indicator marking (e.g. triangle 146), and which is repositionable relative to either of first and second identical and fixed hour markings 1-12 (see at 148 and 150) presented (such as printed or otherwise applied) onto both right and left sides of dial face 152. In the example shown, the right breast was last expressed at 8 o'clock. The markings 148 and 150 can further be imprinted onto dial face 152 and do not require a circle separating them from the dial face 152.

Having described my invention, other and additional preferred embodiments will become apparent to those skilled in the art to which it pertains, and without deviating from the scope of the appended claims. Such can, without limitation, include the analog hands defining the live time display being substituted by a digital readout, with the left/right side directional indicator and/or circumferentially spaced and arrayed hour markings being retained as per the various alternate expressions defined in FIGS. 11-16.

I claim:

1. A breastfeeding assist timepiece, comprising:
a three dimensional housing containing a live time display supported upon a display face and including a separate exterior adjustment feature;
a left/right side directional indicator associated with a selected one of said display face and a rotatable element supported either around or within said housing;
a second static time indicator associated with the other selected one of said display face and rotatable element; and
said static time indicator being continuously reset to a time of a most recently completed feeding, said left/right side directional indicator further designating a left or right breast employed first in the most recent feeding and in order to more accurately predict the timing of a present or future feeding, as well as which breast to be initially employed in that feeding.

2. The timepiece as described in claim 1, said live time display further comprising an analog display, said rotatable element further comprising a left/right side directional indicator in the form of a position indicator defined upon a rotatable outer bezel and being repositionable between right and left sides of said display face in order to indicate a last breast expressed.

3. The timepiece as described in claim 2, further comprising a secondary rotatable element configured as an inner ring supported within said housing and which includes a secondary directional indicator which is resettable to various time locations established upon said display face.

4. The timepiece as described in claim 2, further comprising a beveled gear relationship established between an externally located rotating wheel supported upon said housing and an internal gear which transfers rotation of said wheel to rotary adjustment of said inner ring.

5. The timepiece as described in claim 1, further comprising first and second sets of circumferential spaced hour markings imprinted upon corresponding first and second sides of said display face, said rotatable element further comprising an exterior bezel supporting a combined left/right side and prior feeding indicator and which is adjustable to an aligning location with a selected hour marking on either of said first and second sides.

6. The timepiece as described in claim 1, further comprising a set of circumferential spaced hour markings imprinted upon an outer rotatable bezel and which are adjustable to an aligning location with either of left/right side markings located on an inner dial face.

7. The timepiece as described in claim 1, said rotatable element further comprising an inner ring supported within said housing and exhibiting a set of circumferential spaced hour markings imprinted thereupon which are adjustable to an aligning location with fixed left/right side markings imprinted upon either of the watch housing or said display face.

8. The timepiece as described in claim 1, said rotatable element further comprising an inner ring supported within said housing and exhibiting a single indicator marking, first and second sets of circumferential spaced hour markings imprinted upon corresponding first and second sides of said display face, relative to which said single indicator marking is aligned.
